(19) United States
(12) Patent Application Publication
(10) Pub. No.: US 2006/0076882 A1
(43) Pub. Date: Apr. 13, 2006

(54) Color-adjustable light apparatus and manufacturing method thereof

(75) Inventors: Shih Hsiung Chan, Hsinchu County (TW); Jian Shihn Tsang, Taipei County (TW)

Correspondence Address: HOFFMANN & BARON, LLP, 6900 JERICHO TURNPIKE, SYOSSET, NY, 11791, US

(73) Assignee: Advanced Optoelectronic Technology Inc.

(21) Appl. No.: 11/184,332

(22) Filed: Jul. 19, 2005

(30) Foreign Application Priority Data
Sep. 27, 2004 (TW) 093129200

(51) Int. Cl. H01J 1/62

(52) U.S. Cl. 313/502; 313/503; 313/512; 362/84

(57) ABSTRACT

A color-adjustable light apparatus comprises a light device that emits initial light and a nanometer fluorescent material. The nanometer fluorescent material, which is made of at least one of sulfide and an activated sulfide, absorbs the initial light and emits fluorescence that is different from the initial light in terms of wavelength. The initial light and the fluorescent light combine to produce the required daylight or color light.

### BACKGROUND OF THE INVENTION

1. Field of the Invention

The present invention relates to a color-adjustable light apparatus and the manufacturing method thereof, and more particularly, to a semiconductor photoelectronic device that comprises a nanometer fluorescent material.

2. Description of the Related Art

A light emitting diode (LED) is a photoelectric device that automatically emits light when electrically connected. Small, electrically efficient and good for initial driving, LEDs are widely used in general illumination, large billboards, and backlight sources for monitors.

At present, according to the semiconductor materials of which they are made, LEDs are divided into different categories, namely GaAs, GaAs1-xPx and GaP. In addition, nitrogen-doped semiconductor materials of GaAs1-xPx or GaP families produce rays of multiple colors. In general, light emitted by an LED is characterized by a monochromatic wavelength which depends on the variation of energy involved in light-emitting electron transfer. The lights of wavelengths in use include infrared, red light, green light, yellow light and blue light. Human beings can see different colors of light because the human eye perceives three different colors of light, namely red light, green light and blue light which are collectively known as “primary colors” (RGB).

With juxtaposed LEDs of red wavelength, green wavelength and blue wavelength respectively, a light of any other color is produced by means of mixing. U.S. Pat. No. 5,995,070 discloses a displaying device comprising juxtaposed light sources wherein each pixel is composed of diodes of a red light source, a blue light source and two green light sources.

White light produced by mixing light sources of different wavelengths as mentioned above has problems in hue and brightness dispersion, thus it is rather difficult to produce the intended white light. In addition, since the light source of white light is composed of diodes of different electrical properties which have to be controlled by appropriate driving circuits respectively, the design of the system is complex.

Furthermore, U.S. Pat. No. 6,614,179 discloses a method for producing white light that involves using an LED to emit blue light which, in turn, excites phosphor so that the excited phosphor emits yellow light, and then the two light sources combine to form white light by means of mixing, wherein the wavelength of the blue light ranges between 420 nm and 490 nm, and the phosphor is composed of {[(Y, Gd) Sm] (AlGa) O:Ce}. However, the white light produced by the method hardly expresses the real colors of an object, or, in other words, its color temperature is relatively high and thus its color rendering index is unsatisfactory.

Therefore, to develop white light of a high color rendering index, it is necessary to control or regulate the proportions of individual color lights in the light emitted by the light sources so that the emitted light approximates daylight in terms of the proportions of constituents, and in consequence colors of an object illuminated by the emitted light look vivid. Beside, as regards fluorescent materials, the focus of their research and development is the constituents of yttrium aluminum garnet (YAG) crystal (molecular formula: X₃(A₃B₂)O₁₂) for the time being, for example, Y₃(Al₃Al₂)O₁₂, (Y₃₋ₓCeₓ)Al₅O₁₂, (Y_{2.9}Tb_{0.05})Al₅O₁₂, and (Y_{2.95-a}Ce_{0.05}Gdₐ)(Al_{5-b}Ga_{b})O₁₂ in YAG phosphor structure.

In short, the market is urgently in need of a light apparatus that emits light similar to daylight in terms of proportions of constituents wherein the colors of the light emitted by the light apparatus are adjusted at will by combining nanometer phosphors of various properties.

### SUMMARY OF THE INVENTION

An objective of the present invention is to provide a color-adjustable light apparatus and the manufacturing method thereof wherein the nanometer fluorescent material, which is a mixture of sulfides and sulfides activated by rare-earth elements, absorbs the initial light and gets excited, and in the excitement it emits a fluorescent light which is different from the initial light in terms of wavelength. The initial light and the fluorescent light combine to produce light of multiple wavelengths.

Another objective of the present invention is to provide a color-adjustable light apparatus and the manufacturing method thereof wherein the light apparatus emits white light as a result of the combination of various sulfides and sulfides activated by rare-earth elements.

To achieve the objectives, the present invention discloses a color-adjustable light apparatus wherein the light apparatus comprises a light device that emits initial light and a nanometer fluorescent material. The nanometer fluorescent material, which is made of either at least one sulfide or an activated sulfide, absorbs the initial light and emits a fluorescent light which is different from the initial light in terms of wavelength. The initial light and the fluorescent light combine to produce the required daylight or color light.

The nanometer fluorescent material contains sulfides, such as calcium sulfide (CaS), strontium sulfide (SrS) and barium sulfide (BaS), and may also contain activator-doped sulfides, such as calcium sulfide:europium (CaS:Eu), and calcium sulfide:cerium (CaS:Ce), wherein calcium sulfide provides blue fluorescent light, and calcium sulfide:europium provides red fluorescent light, and calcium sulfide:cerium provides green fluorescent light. Nano-particles of the fluorescent material, such as calcium sulfide, calcium sulfide: europium, and calcium sulfide:cerium, are mixed and the mixture is well-proportioned. As a result, the initial light combines with the light emitted by the fluorescent material in excitement to form white light or default color light.

The method for manufacturing the color-adjustable light apparatus involves the following steps: providing a light device, which emits initial light and is installed by fixing and electrically connecting an electroluminescent semiconductor device to a lead frame or a substrate; coating and protecting the semiconductor device with a molding member; and installing a nanometer fluorescent material in a place illuminated by the light emitted by the light device wherein the nanometer fluorescent material is made of at least one of a sulfide and an activator-doped sulfide.

### BRIEF DESCRIPTION OF THE DRAWINGS

The invention will be described according to the appended drawings in which:

FIG. 1 is a schematic diagram of a color-adjustable light apparatus in accordance with the present invention;

FIGS. 2-4 are spectrum diagrams of several nanometer fluorescent materials in accordance with the present invention; and

FIG. 5 is a chromaticity diagram of nanometer fluorescent materials in accordance with the present invention.

### PREFERRED EMBODIMENT OF THE PRESENT INVENTION

As discovered by research and development of nanotechnology, when matter particles are miniaturized to a nano-scale size, it would create quantum effect, and at that point there would be changes in the energy level, physical properties and chemical properties of the material.

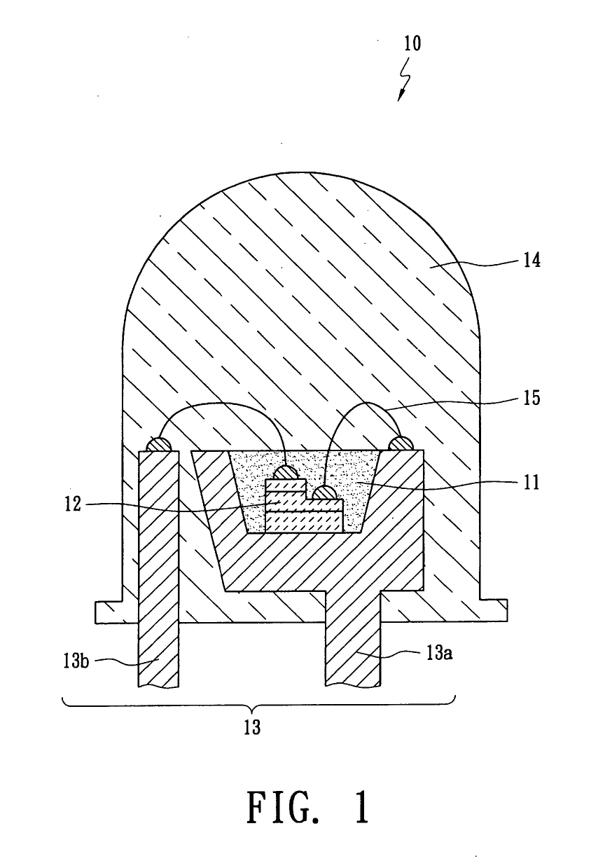

FIG. 1 is a schematic diagram of a color-adjustable light apparatus in accordance with the present invention. The light apparatus 10 comprises a die 12 of the semiconductor device fixed to the cup-shaped member of a lead frame 13; and the die 12 is electrically connected to the cathode 13a and anode 13b of the lead frame 13 respectively through a metallic lead 15, so as to form a light device. The die 12, which can be either an LED or a laser diode, is preferably a light-emitting semiconductor having a nitride-based luminous layer. The cup-shaped member is filled with a nanometer fluorescent material 11, thus the die 12 emits initial light when electrically powered by an external power source. The surrounding nanometer fluorescent material 11 is excited by the initial light, and in the excitement it emits fluorescent light which is different from the initial light in wavelength. The initial light and the fluorescent light combine to form light of multiple wavelengths, and the light of multiple wavelengths is emitted after penetrating a molding member 14. The molding member 14, which appears in the form of transparent epoxy, coats the die 12; the nanometer fluorescent material 11 may be incorporated into the epoxy, and then the mixture is injected into a bullet-shaped mold cavity for molding. Furthermore, the nanometer fluorescent material 11 may also be applied to the surface of the molding member 14 to achieve optical mixing equally well as the aforesaid option does, thus the present embodiment does not impose any restraint on the position of the nanometer fluorescent material 11. In addition to the lead frame 13, the die 12 may be fixed to the substrate to make an SMD (surface mount device) type light apparatus.

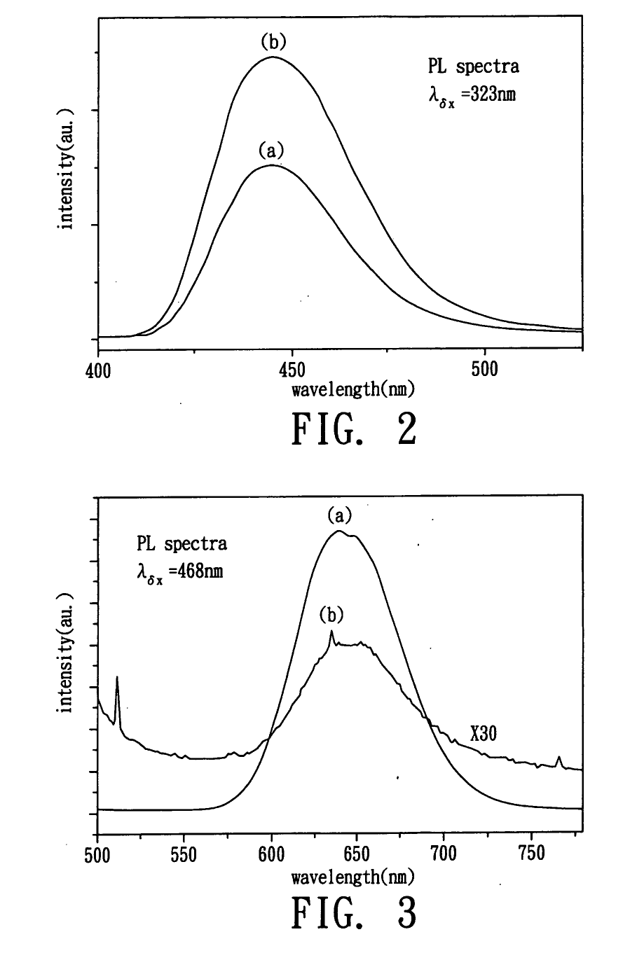

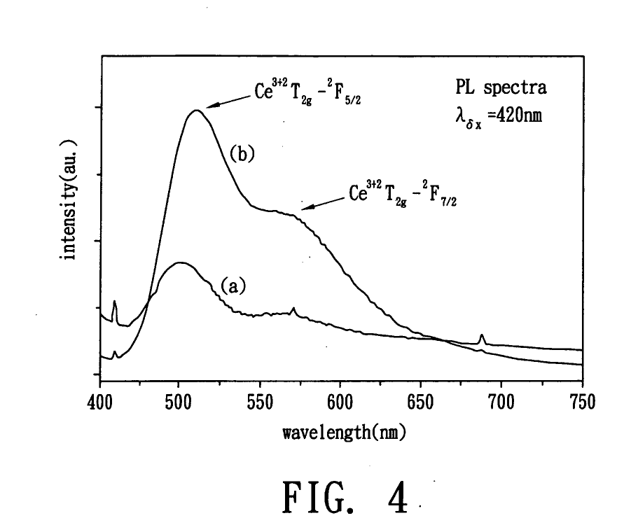

The nanometer fluorescent material 11 is made of either at least one sulfide or an activated sulfide. The sulfides include alkaline-earth sulfides, such as calcium sulfide, strontium sulfide and barium sulfide. The activated sulfides include any of the aforesaid sulfides which are rare-earth element-doped. As exemplified by the rare-earth element-doped sulfides, calcium sulfide provides blue fluorescent light as shown in FIG. 2, and calcium sulfide:europium provides red fluorescent light as shown in FIG. 3, and calcium sulfide: cerium provides green fluorescent light as shown in FIG. 4. Curves (a) and (b) in FIGS. 2 and 3 illustrate the sulfides or activated sulfides grown with different manufacturing processes and methods wherein Curve (a) and Curve (b) show that photo-electroluminescence spectra vary with the formation, that is, the materials are separately developed by the methods of solid-state and microemulsion routes.

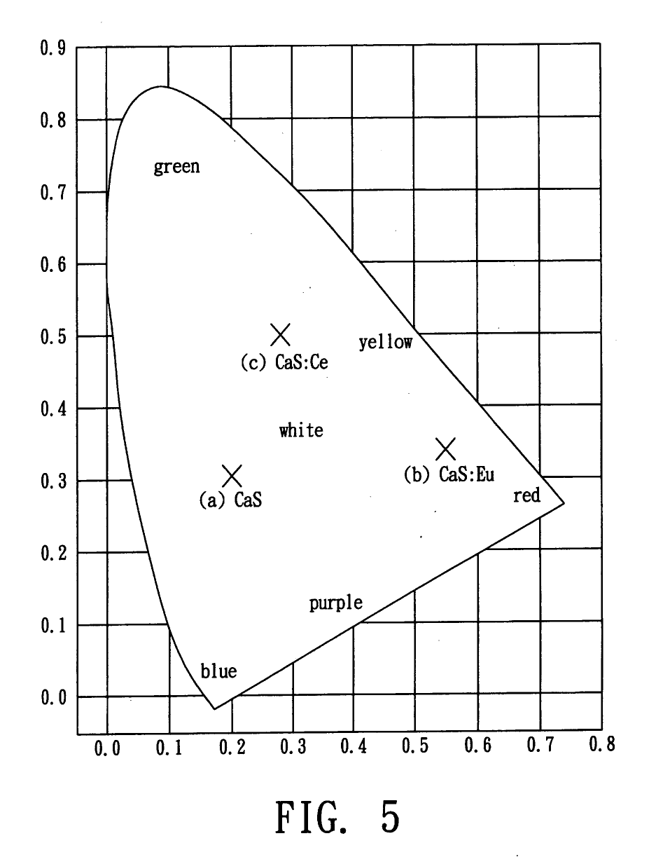

As shown in FIG. 5, nano-particles of the fluorescent material, such as (a) calcium sulfide, (b) calcium sulfide: europium, and (c) calcium sulfide: cerium, are mixed and the mixture is well-proportioned, and as a result, the initial light combines with the light emitted by the fluorescent material in excitement to form white light or default color light. Referring to the chromaticity diagram in FIG. 5, assuming the die 12 is the LED that emits blue light (wherein the spectral peak is located at the region below 550 nm), it is feasible to incorporate the nanometer fluorescent material, which is a mixture of calcium sulfide:europium and calcium sulfide: cerium, into the light apparatus 10, so as to make the final fluorescent light (of wavelength greater than 550 nm) combine with the blue light to form white light. The size of the nano-particles has to be less than 5 μm, and the preferred size ranges between 1 and 100 nm.

The method for manufacturing the light apparatus 10 having adjustable color light involves the following steps: providing a light device, which emits initial light and is installed by fixing and electrically connecting an electroluminescent semiconductor die 12 to a lead frame 13 or a substrate; coating and protecting the semiconductor device with a molding member 14; and installing a nanometer fluorescent material 11 in a place illuminated by the light emitted by the light device wherein the nanometer fluorescent material is made of either at least one sulfide or an activator-doped sulfide.

The above-described embodiments of the present invention are intended to be illustrative only. Numerous alternative embodiments may be devised by persons skilled in the art without departing from the scope of the following claims.

What is claimed is:

1. A color-adjustable light apparatus, comprising:
a light device capable of emitting initial light;
a molding member overlaid on the light device; and
at least one nanometer fluorescent material used for being excited by the initial light so as to emit fluorescent light which is different from the initial light, wherein the nanometer fluorescent material is composed of at least one of a sulfide and an activator-doped sulfide;
whereby the initial light and the fluorescent light are combined to emit light of multiple wavelengths.

2. The color-adjustable light apparatus of claim 1, wherein the light device is a light-emitting diode (LED).

3. The color-adjustable light apparatus of claim 2, wherein the LED has a luminous layer of a nitride semiconductor.

4. The color-adjustable light apparatus of claim 1, wherein the sulfide is an alkaline-earth sulfide.

5. The color-adjustable light apparatus of claim 1, wherein the nano-particle of the nanometer fluorescent material is less than 5 μm in diameter.

6. The color-adjustable light apparatus of claim 1, wherein the nano-particle of the nanometer fluorescent material is between 1-100 nm in diameter.

7. The color-adjustable light apparatus of claim 1, wherein the activator-doped sulfide is an activator-doped alkaline-earth sulfide.

8. The color-adjustable light apparatus of claim 1, wherein the activator-doped sulfide is activated by a rare-earth element.

9. The color-adjustable light apparatus of claim 1, wherein the light device includes a lead frame and a semiconductor device attached on the lead frame.

10. The color-adjustable light apparatus of claim 1, wherein the light device includes a substrate and a semiconductor device attached on the substrate.

11. The color-adjustable light apparatus of claim 1, wherein the nanometer fluorescent material is overlaid on the light device.

12. The color-adjustable light apparatus of claim 1, wherein the spectral peak of the initial light is below 550 nm.

13. The color-adjustable light apparatus of claim 1, wherein the initial light and the fluorescent light are combined to form white light.

14. A manufacturing method of a color-adjustable light apparatus, comprising the steps of:
providing a light device capable of emitting initial light;
overlaying the light device with a molding member; and
exciting a nanometer fluorescent material with the initial light to emit fluorescent light different from the initial light;
wherein the nanometer fluorescent material is composed of at least one of a sulfide and an activator-doped sulfide.

15. The manufacturing method of a color-adjustable light apparatus of claim 14, further comprising a step of attaching an LED to a lead frame to have the light device.

16. The manufacturing method of a color-adjustable light apparatus of claim 15, wherein the LED has a luminous layer of a nitride semiconductor.

17. The manufacturing method of a color-adjustable light apparatus of claim 14, further comprising a step of attaching an LED to a substrate to form the light device.

18. The manufacturing method of a color-adjustable light apparatus of claim 17, wherein the LED has a luminous layer of a nitride semiconductor.

19. The manufacturing method of a color-adjustable light apparatus of claim 14, wherein the sulfide is an alkaline-earth sulfide.

20. The manufacturing method of a color-adjustable light apparatus of claim 14, wherein the nano-particle of the nanometer fluorescent material is less than 5 μm in diameter.

21. The manufacturing method of a color-adjustable light apparatus of claim 14, wherein the nano-particle of the nanometer fluorescent material is between 1-100 nm in diameter.

22. The manufacturing method of a color-adjustable light apparatus of claim 14, wherein the activator-doped sulfide is an activator-doped alkaline-earth sulfide.

23. The manufacturing method of a color-adjustable light apparatus of claim 14, wherein the activator-doped sulfide is activated by a rare-earth element.

24. The manufacturing method of a color-adjustable light apparatus of claim 14, wherein the nanometer fluorescent material is directly overlaid on the light device.

25. The manufacturing method of a color-adjustable light apparatus of claim 14, wherein the spectral peak of the initial light is below 550 nm.

26. The manufacturing method of a color-adjustable light apparatus of claim 14, wherein the initial light and the fluorescent light are combined to form white light.
